(19) United States
(12) Patent Application Publication
(10) Pub. No.: US 2008/0136072 A1
(43) Pub. Date: Jun. 12, 2008

(54) Pneumatic Spring Comprising a Ball Joint

(75) Inventors: Wolfgang Kolb, Werneck (DE); Ulrich Geyer, Dittelbrunn (DE); Christian Loesche, Stemwede (DE); Reinhard Richter, Bohmte (DE); Hans-Gerd Brunneke, Georgsmarienhuette (DE)

Correspondence Address: COHEN, PONTANI, LIEBERMAN & PAVANE, 551 FIFTH AVENUE, SUITE 1210, NEW YORK, NY, 10176, US

(73) Assignee: ZF FRIEDRICHSHAFEN AG, Friedrichshafen (DE)

(21) Appl. No.: 11/662,291

(22) PCT Filed: Sep. 28, 2005
(86) PCT No.: PCT/EP05/10463

§ 371 Date: Mar. 8, 2007

(30) Foreign Application Priority Data
Oct. 7, 2004 (DE) 10 2004 048 828.2

(51) Int. Cl. F16F 9/05; B60G 11/28

(52) U.S. Cl. 267/140.11

(57) ABSTRACT

The invention relates to a pneumatic spring (1) comprising a roll bellow (3) which is secured to an unrolling tube (7) and which forms a spring space therewith (9). The unrolling tube (7) is connected to a base part (11) by means of a ball joint (13) which comprises a spherical bearing element (15) contained in the bearing shell. The bearing shell (17) can be adjusted in relation to the spherical bearing element (15) by means of a clamping element (25).

### TECHNICAL AREA

The invention pertains to a pneumatic spring according to the introductory clause of claim 1.

### PRIOR ART

FIG. 6 of DE 199 59 839 A1 shows a pneumatic spring with a rolling bellows attached to a roll-down tube. A ball joint is installed between a base part—in this case, a vibration damper—and the roll-down tube. The ball joint consists of a spherical bearing element, which is located in a two-part bearing shell. A seal, which seals off the spring space of the pneumatic spring, is present between the two halves of the bearing shell.

In this ball joint, dimensional deviations lead to increased internal friction or, in the other extreme case, in which the seal is not adequately pretensioned between the bearing shells, to the generation of noise and to leakage.

The task of the present invention is to improve the ball joint especially intended for pneumatic springs in such a way that the problems familiar from the prior art with respect to friction and leakage are eliminated.

### DESCRIPTION OF THE INVENTION

According to the invention, the task is accomplished in that the bearing shell can be tightened onto the spherical bearing element by means of a clamping element.

The bearing play between the bearing shell and the spherical bearing element can be adjusted precisely to the desired value, so that the friction problem is solved.

In a concrete embodiment of the invention, the bearing shell has a conical gripping surface on the outside, against which the clamping element acts. The clamping element exerts an axial tensioning movement which reduces the diameter of the bearing shell.

So that the bearing shell will be radially pretensioned in a uniform manner, the clamping element is formed by a tension ring. The clamping element is braced against a support sleeve and is itself therefore well centered.

The spherical bearing element, the bearing shell, the tension ring, and the support sleeve form a closed structural unit, because the support sleeve cooperates with an additional gripping surface on the bearing shell, which, relative to the equator of the spherical bearing element, is opposite the first gripping surface.

So that the bearing shell can be adjusted in a continuously variable manner, a threaded joint is present between the clamping element and the support sleeve.

The bearing shell is elastic, so that the adjusting forces which must be exerted on the tension ring remain with limits. If, for example, the friction increases because of the heating of the ball joint, the tension ring can be loosened slightly. The bearing shell, because of its intrinsic elasticity, will assume an appropriately modified contour.

The bearing shell, furthermore, is designed as a one-piece part. Making the shell in one piece offers a considerable advantage with respect to fabrication. The bearing shell is pushed over the spherical bearing element, and after this they cannot come apart.

So that a basically inelastic material can also be used for the bearing shell, the bearing shell is slotted. Either one slot extending longitudinally or several slots, which proceed from one end of the bearing shell to a point past the equator of the spherical bearing element can be provided.

In another advantageous embodiment, a seal separates the spring space from the bearing shell. The pretension of the bearing shell is therefore independent of the pretension of the seal, so that there can be no conflict between the goal of obtaining the desired bearing play and the goal of sealing the pneumatic spring effectively.

The seal is designed as a lip seal, which is pretensioned onto the spherical bearing element as a function of the pressure inside the spring space. The seal is held in place axially between the roll-down tube and the support sleeve, so that there is no need to machine a separate sealing groove into the roll-down tube for the seal.

The support sleeve is held in place radially by the roll-down tube and is held in place axially by a retaining ring on the roll-down tube. During assembly, the ball joint unit is simply pushed into the roll-down tube and attached by means of the previously mentioned retaining ring.

According to an advantageous application, the base part is formed by a vibration damper, which passes through the spherical bearing element.

The ball joint is simply set down on top of the base part. To prevent leaks, a seal is placed between the base part and the spherical bearing element.

It should be possible to adjust the bearing play inside the ball joint quickly and easily, nor should any damage be thus caused. For this reason, the clamping element is provided with flats for a wrench.

In certain applications of the ball joint with a pneumatic spring, it would be possible for dirt particles from the vehicle to intrude into the ball joint. So that this cannot occur with the inventive ball joint, it is covered by a protective bellows.

If it is necessary to remove the ball joint to allow repairs, one end of the protective bellows, which is attached to the tension ring, can be removed very easily to provide free access to the ball joint. A simple spring clamp holds the end of the protective bellows firmly in place on the tension ring.

### SHORT DESCRIPTION OF THE FIGURES

The invention is to be explained in greater detail on the basis of the following description of the figures:

FIG. 1 shows an overall view of a pneumatic spring with a vibration damper;

FIG. 2 shows a transverse section of a ball joint assembly; and

FIGS. 3 and 4 show views of the bearing shell of the ball joint.

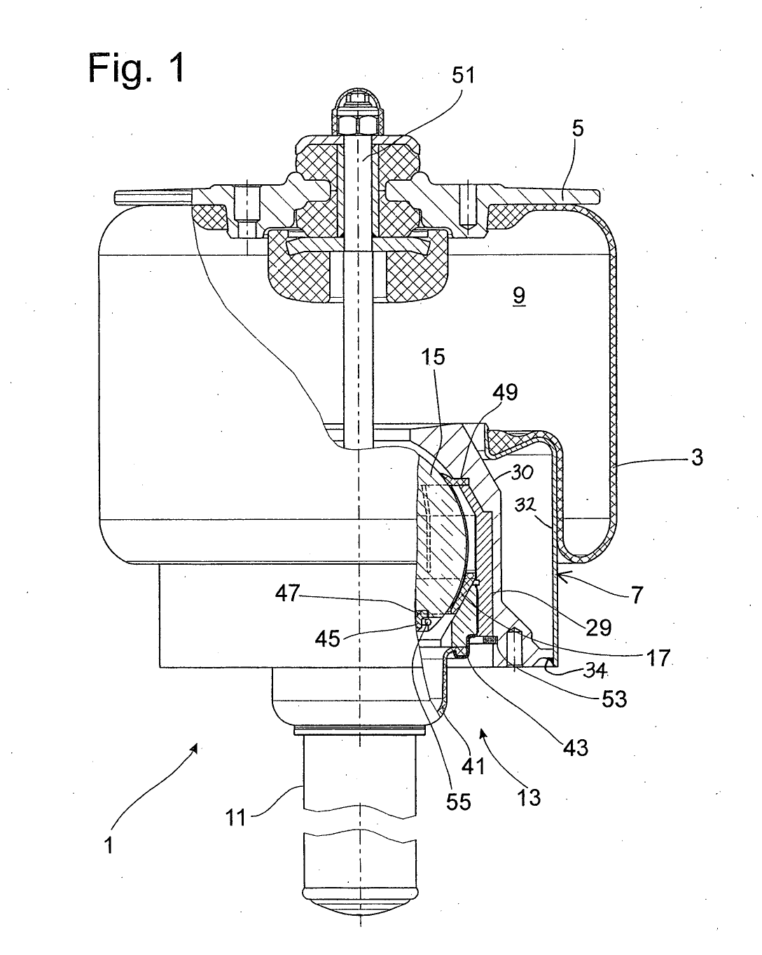

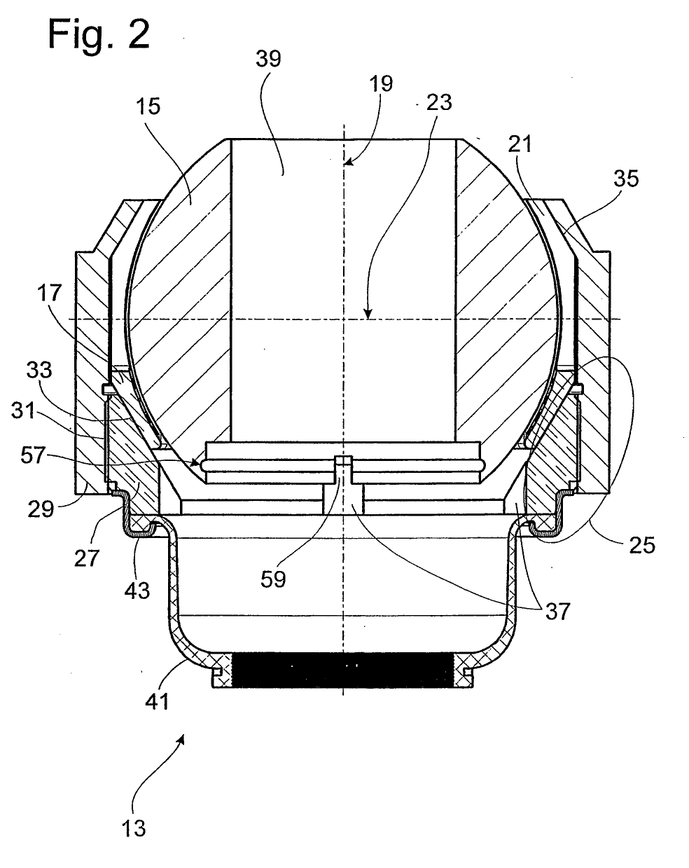

FIG. 1 shows a pneumatic spring 1 with a rolling bellows 3, the upper end of which is supported on a connecting plate 5. The other end of the rolling bellows is attached to a roll-down tube 7. The rolling bellows and the roll-down tube form the boundaries of a spring space 9, which is connected to a compressed air supply (not shown). Between the roll-down tube 7 and a base part in the form of a known vibration damper 11, a ball joint 13 is provided, which is shown as an isolated assembly in FIG. 2.

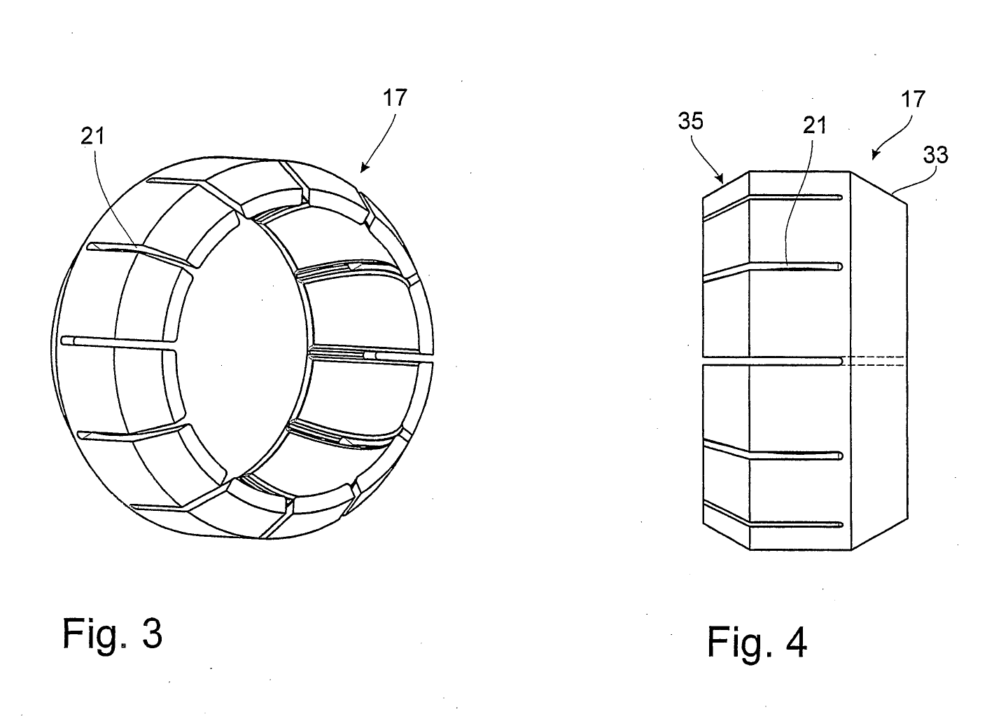

It can be seen in FIG. 2 that the ball joint has a spherical bearing element 15, which makes possible rotational movements in the circumferential direction in a bearing shell 17 and also makes it possible for the spherical bearing element to execute pivoting movements relative to a longitudinal axis 19. The bearing shell 17 is designed as a one-piece part, as can be seen in FIGS. 3 and 4. The bearing shell, furthermore, is elastic especially in the radial direction, so that it can be pushed over the spherical bearing element 15 during installation. The bearing shell has slots 21, which extend from the upper end to a point beyond the equator 23 (see FIG. 2). Alternatively, it is also possible to provide a single continuous slot, such as that shown in broken line.

The bearing shell 21 can be adjusted with respect to the spherical bearing element 15 by means of a clamping element 25. The clamping element 25 is formed in part by a tension ring 27, which is braced against a support sleeve 29. Between the clamping element, i.e., the tension ring 27, and the support sleeve 29 there is a threaded joint 31, which makes it possible for the tension ring to be moved axially with respect to the support sleeve in a continuously variable manner. On the outside, the bearing shell has a conical first gripping surface 33 (see also FIG. 4), on which the tension ring 27 acts. The support sleeve 29 cooperates with another gripping surface 35 on the bearing shell 17, which, relative to the equator 23 of the spherical bearing element 15, is opposite the first gripping surface 33.

The spherical bearing element 15, the bearing shell 17, the tension ring 27, and the support sleeve 29 form a closed ball joint assembly, which can be adjusted after installation. For this purpose, the tension ring has flats 37 for a wrench to make it easier to turn the tension ring with respect to the support sleeve. The two gripping surfaces 33, 35 of the tension ring and the support sleeve are deformed toward the spherical bearing element 15, as a result of which the ball joint can be adjusted precisely with respect to its bearing play.

The spherical bearing element has a through-opening 39 to hold the vibration damper 11 (FIG. 1). In the direction facing the vibration damper, the ball joint is covered by a protective bellows 41, which is attached at one end to the tension ring 27 by means of a locking ring 43.

During the assembly of the pneumatic spring, the previously mentioned unit is threaded onto the vibration damper 11. An angle ring 45 is attached to the vibration damper 11, and a seal 47, attached to the vibration damper, is provided between the spherical bearing element 15 and the base part 11, i.e., the angle ring, to prevent leakage between the ball joint 13 and the vibration damper. In a further step of the assembly process, a seal 49 is mounted on the end surface of the support sleeve 29; this seal separates the spring space 9 from the bearing shell 17. The seal 49 is designed as a lip seal, which is pretensioned onto the spherical bearing element 15 as a function of the pressure inside the spring space 9.

Then the roll-down tube 7 is pushed onto the support sleeve 29 from the direction of the piston rod 51 of the vibration damper 11, so that the seal 49 is held in place axially between the roll-down tube 7 and the support sleeve 29. The support sleeve in turn is held in place radially by the roll-down tube and is fixed axially by retaining ring 53.

So that the vibration damper 11 cannot fall out of the ball joint 13, a retaining ring 55 is accommodated in a groove 57 (FIG. 2) between the angle ring 45 and the spherical bearing element 15. To remove the retaining ring 55, an axial slot 59 is provided in the groove 57; this groove provides access for a tool, which can press the retaining ring out of the groove 57. Then the protective bellows 41 is mounted and held in place by the locking ring.

Because of the ball joint with optimal bearing play, the module consisting of the pneumatic spring and the vibration damper now present can be used to compensate for cardanic movements between, for example, a vehicle axle and a vehicle body, in a manner characterized not only by low friction but also by the absence of leakage.

1-19. (canceled)

20. A pneumatic spring comprising:
a base part;
a ball joint connected to the base part, the ball joint comprising a spherical bearing element and a radially resilient bearing shell engaging the spherical bearing element;
a clamping element for tightening the bearing shell radially onto the spherical bearing element;
a roll-down tube fixed around the clamping element; and
a rolling bellows attached to the roll-down tube and forming a pneumatic spring space.

21. The pneumatic spring of claim 20 wherein the bearing shell has a first conical gripping surface on which the clamping element acts in order to adjust tightness of the bearing shell on the spherical bearing element.

22. The pneumatic spring of claim 21 wherein the clamping element comprises a tension ring surrounding the first conical gripping surface.

23. The pneumatic spring of claim 22 further comprising a support sleeve surrounding the tension ring and supporting the tension ring radially.

24. The pneumatic spring of claim 23 wherein the bearing shell further comprises a second conical gripping surface axially opposite from the first conical gripping surface, the support sleeve bearing against the second conical gripping surface.

25. The pneumatic spring of claim 23 further comprising a threaded joint between the tension ring and the support sleeve.

26. The pneumatic spring of claim 20 wherein the bearing shell is a one-piece part.

27. The pneumatic spring of claim 26 wherein the bearing shell is formed with slots which impart radial resilience.

28. The pneumatic spring of claim 23 further comprising a seal between the bearing shell and the spring space.

29. The pneumatic spring of claim 28 wherein the seal is a lip seal which is loaded against the bearing shell as a function of the pressure inside the spring space.

30. The pneumatic spring of claim 28 wherein the seal is held in place axially between the roll-down tube and the support sleeve.

31. The pneumatic spring of claim 23 wherein the roll-down tube surrounds the support sleeve and supports the support sleeve radially.

32. The pneumatic spring of claim 31 further comprising a retaining ring which holds the roll-down tube in place axially on the support sleeve.

33. The pneumatic spring of claim 20 wherein the base part comprises a vibration damper passing through the spherical bearing element.

34. The pneumatic spring of claim 20 further comprising a seal between the base part and the spherical bearing element.

35. The pneumatic spring of claim 25 wherein the clamping element comprises at least one pair of flats which can be engaged by a wrench.

36. The pneumatic spring of claim 20 further comprising a protective bellows between the base part and the ball joint.

37. The pneumatic spring of claim 22 further comprising a protective bellows between the base part and the ball joint, the protective bellows being connected to the tension ring.
